(19) United States
(12) Patent Application Publication
(10) Pub. No.: US 2025/0166303 A1
(43) Pub. Date: May 22, 2025

(54) EXTRACTING QUAD-MESHES WITH PIXEL-LEVEL DETAILS AND MATERIALS FROM IMAGES

(71) Applicants: DISNEY ENTERPRISES, INC., Burbank, CA (US); ETH Zürich (Eidgenössische Technische Hochschule Zürich), Zürich (CH)

(72) Inventors: Hayko Jochen Wilhelm RIEMENSCHNEIDER, Zürich (CH); Christopher Richard SCHROERS, Uster (CH); Maximilian FRUEHAUF, Zürich (CH)

(21) Appl. No.: 18/949,874

(22) Filed: Nov. 15, 2024

Related U.S. Application Data
(60) Provisional application No. 63/600,014, filed on Nov. 16, 2023.

(51) Int. Cl. G06T 17/20

(52) U.S. Cl. CPC G06T 17/20

(57) ABSTRACT

One embodiment of the present invention sets forth a technique for generating a quad-dominant mesh of an object. The technique includes generating, via at least one of a first set of machine learning models, a three-dimensional (3D) triangle mesh of an object based on one or more two-dimensional input images of the object, iteratively learning, via a second set of machine learning models, an orientation field and a position field associated with a set of vertices included in the 3D triangle mesh, extracting a quad-dominant mesh associated with the object from the input triangle mesh based on the orientation field and the position field, wherein the quad-dominant mesh comprises one or more quadrilaterals, rendering an image based on the quad-dominant mesh; and optimizing the quad-dominant mesh by propagating a loss generated based on the image to the set of machine learning models.

### CROSS-REFERENCE TO RELATED APPLICATIONS

This application claims priority benefit of U.S. provisional patent application titled “EXTRACTING WELL-BEHAVED QUAD MODELS, MATERIALS, AND LIGHTING FROM IMAGES,” Ser. No. 63/600,014, filed Nov. 16, 2023. The subject matter of this related application is hereby incorporated herein by reference.

### BACKGROUND

### Field of the Various Embodiments

Embodiments of the present disclosure relate generally to machine learning and content creation and, more specifically, to extracting quad-meshes with pixel-level details and materials from images.

### Description of the Related Art

In the field of computer graphics, generating high-quality 3D models from real-world images is an important task for applications in visual effects, virtual reality, and interactive media. Traditional production pipelines require numerous high-resolution meshes, often consuming extensive artist time and effort to refine raw 3D scans or model objects manually. Recent advances in neural implicit representations have shown promise in automating parts of this process, enabling more efficient extraction of object geometry and material properties from images. However, these methods typically produce dense or irregular triangle-based meshes that are difficult to manipulate and do not enable detailed control.

Existing approaches, using, for example, Neural Radiance Fields (NeRF) and Signed Distance Fields (SDFs), can generate high-fidelity views and capture object details, but fail to create explicit, editable mesh representations. When extracting meshes, these methods often yield triangle-dominant structures with excessive geometry, limiting their usability in production. Although these meshes can be converted to quad-meshes that enable more fine-grained control, the processes lack control over the topology's alignment with the object's surface features, leading to meshes that are unsuitable for further refinement, subdivision, or animation. Consequently, production artists are left with time-consuming post-processing tasks to make these meshes compatible with professional tools.

Alternative methods, such as triangle-based explicit mesh extraction, produce meshes suitable for differentiable rendering but suffer from irregular face topology. These approaches rely on triangle faces, which suffer from “sliver” triangles that are highly sensitive to deformation, causing artifacts in animation and simulation. Such meshes are also incompatible with quad-based subdivision techniques, which are a mainstay in digital content creation for achieving smooth, detailed surfaces from low-resolution models.

Field-aligned quad remeshing techniques address some of these limitations by converting triangle meshes to quad-dominant ones using orientation and position fields. While effective for static quad generation, these methods are non-differentiable, preventing optimization in an end-to-end framework. They rely on surface heuristics to approximate the geometry, which introduces errors that cannot be corrected during optimization. Additionally, they lack mechanisms for capturing high-frequency details or distinguishing material properties and lighting, further limiting their utility in photorealistic rendering applications.

As the foregoing illustrates, what is needed in the art are more effective techniques for generating editable meshes that are compatible with content production pipelines, minimizing the need for manual post-processing and supporting greater efficiency in creating production-quality 3D assets.

### SUMMARY

One embodiment of the present invention sets forth a technique for generating quad-dominant meshes. The technique includes generating, via at least one of a first set of machine learning models, a three-dimensional (3D) triangle mesh of an object based on one or more two-dimensional input images of the object, iteratively learning, via a second set of machine learning models, an orientation field and a position field associated with a set of vertices included in the 3D triangle mesh, extracting a quad-dominant mesh associated with the object from the input triangle mesh based on the orientation field and the position field, wherein the quad-dominant mesh comprises one or more quadrilaterals, rendering an image based on the quad-dominant mesh; and optimizing the quad-dominant mesh by propagating a loss generated based on the image to the set of machine learning models.

One technical advantage of the disclosed techniques relative to the prior art is that the resulting quad-dominant mesh is directly compatible with rendering pipelines, as the mesh is a surface-only representation of the object with suitable topology for subdivision with decomposed material properties. Further, large scale features are represented in the quad-dominant mesh, while smaller scale features, e.g., features that are smaller than the quad-dominant edge length, are represented using displacement. This coarse and fine-grain representation gives an artist operating on the resulting mesh explicit editability of the small scale features. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a detailed illustration of a mesh generator pipeline, according to various embodiments.

FIG. 3 illustrates an example execution of the mesh generator pipeline, according to various embodiments.

FIG. 4 is a flow diagram of method steps for generating a quad-dominant mesh associated with an object in an input image, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

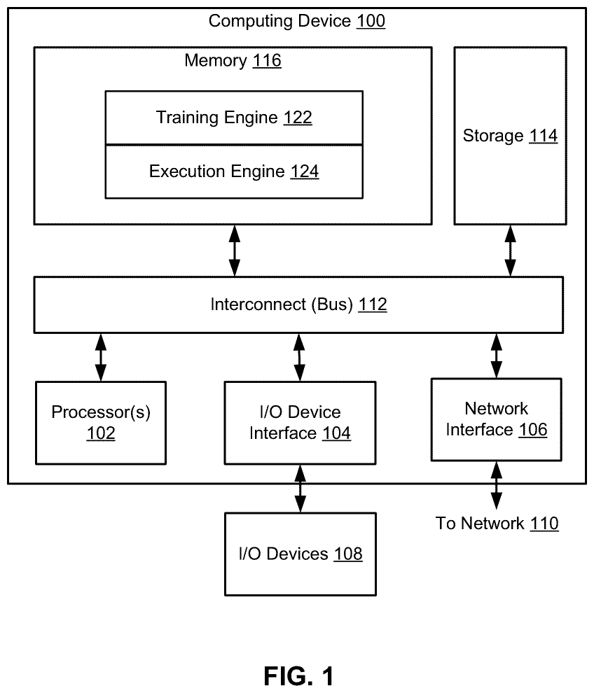

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and an execution engine 124 that reside in memory 116.

It is noted that the computing device described herein is illustrative and that any other technically feasible configurations fall within the scope of the present disclosure. For example, multiple instances of training engine 122 and execution engine 124 could execute on a set of nodes in a distributed and/or cloud computing system to implement the functionality of computing device 100. In another example, training engine 122 and/or execution engine 124 could execute on various sets of hardware, types of devices, or environments to adapt training engine 122 and/or execution engine 124 to different use cases or applications. In a third example, training engine 122 and execution engine could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 and execution engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 trains one or more machine learning models of a 3D mesh generation pipeline to generate a 3D quad-dominant mesh of an object based on 2D images of the object. Execution engine 124 uses the trained pipeline to generate an optimized quad-dominant mesh for objects in 2D images. These quad-dominant meshes can be used in various 3D reconstruction tasks.

### Quadmesh Generation Pipeline

The disclosed embodiments include an end-to-end differentiable pipeline for reconstructing input images of an object into a three-dimensional quad-dominant mesh associated with the object. The system represents large-scale object shapes through surface meshes, while high-frequency details are captured as displacement and material roughness. The pipeline includes an iterative mesh optimization process for generating, based on a triangle mesh, a high-quality quad-dominant mesh through the optimization of orientation and position fields associated with the triangle mesh. This optimization process is guided by fitting the shape of the object with a Signed Distance Function (SDF), which enables accurate surface reconstruction. The pipeline also includes a differentiable Catmull-Clark subdivision algorithm and pixel-level displacement mapping to capture fine details at a resolution beyond individual quad faces. Further, the pipeline includes a differentiable renderer that extracts spatially-varying materials and environmental lighting information, resulting in high-quality meshes that are fully compatible with existing production pipelines. This end-to-end optimization of surface geometry, orientation and position fields, material, and lighting parameters achieves competitive results in geometry reconstruction and view interpolation, having high surface accuracy and improved topology driven by an image loss function.

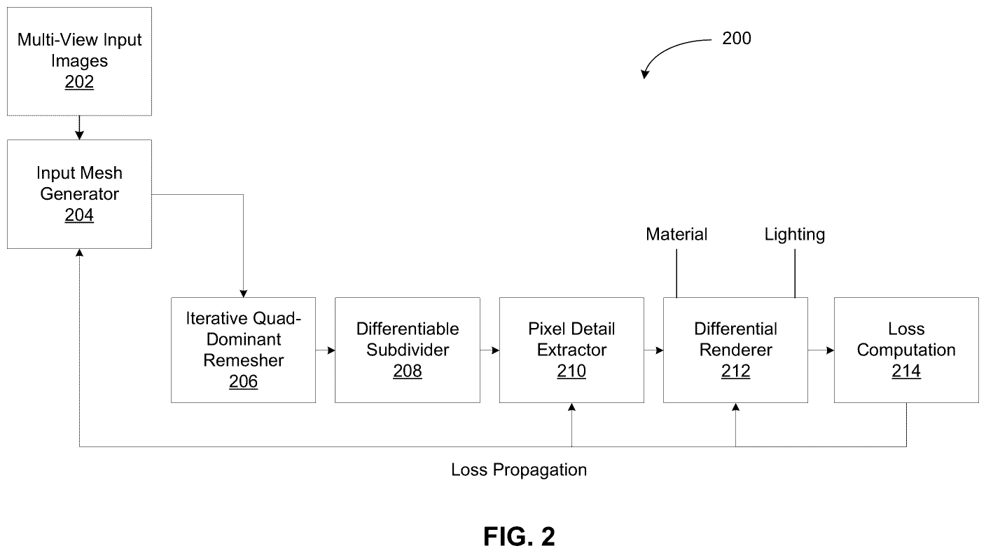

FIG. 2 is a detailed illustration of a mesh generator pipeline 200, according to various embodiments. Mesh generator pipeline 200 is an end-to-end pipeline for generating a three-dimensional (3D) quad-dominant mesh associated with an object based on one or more two-dimensional (2D) images of the object. The mesh generator pipeline 200 receives as input multi-view input images 202 and processes those images via stages of the pipeline including an input mesh generator 204, an iterative quad-dominant remesher 206, a differentiable subdivider 208, pixel detail extractor 210, a differentiable renderer 212, and loss computation and propagation 214.

In operation, the input mesh generator 204 processes the input images 202 of an object to generate a triangle mesh associated with the object. In various embodiments, the input mesh generator 204 generates a neural signed distance function (SDF) to represent the input images 202. An SDF represents a continuous volumetric field that assigns a value to each point in 3D space that indicates its signed distance from the closest surface. In various embodiments, one or more networks are trained to learn the SDF, enabling accurate modeling of complex shapes and surfaces by encoding them within the network's parameters. Using SDFs allows for continuous, differentiable representations of object surfaces.

In various embodiments, the surface of the object can implicitly be represented by its zero-level set S={x∈R³|s(x)=0}. For each position x, the SDF s(x) measures the signed distance to the surface, positive outside and negative inside. Such an SDF s(x) can be learned using a neural network, such as a Multi-Layer Perceptron (MLP). In various embodiments, combining an MLP with a multi-resolution hash-grid encoding to learn s(x) is effective both in terms of representational power and memory consumption. For each vertex x, the hash-grid encoder enc(x):R³→R^{f×d} linearly interpolates a feature vector Fᵢ∈R^{d} from a grid at each level of the hierarchy. In various embodiments, to improve efficiency, instead of representing dense feature grids in memory, a spatial hash maps query positions to features, which get concatenated together to form the final feature vector F∈R^{f×d}.

Once the SDF is generated, the input mesh generator 204 extracts the triangle mesh by querying the SDF at the vertices of a discrete voxel grid and linearly approximating the surface location. For example, methods such as Marching Cubes (MC) or Marching Tetrahedra (MT) may be used for such extraction. For any two grid vertices xᵢ, xⱼ with sign(s(xᵢ))≠sign(s(xⱼ)) on a shared edge of a cube or tetrahedron, the surface vertex xᵢⱼ is computed as:

$${x}_{ij} = \frac{{x}_{i} s ( {x}_{j} ) - {x}_{j} s ( {x}_{i} )}{s ( {x}_{j} ) - s ( {x}_{i} )}$$

The iterative quad-dominant remesher 206 generates a quad-dominant mesh based on the triangle mesh. A quad-dominant mesh is a type of 3D mesh primarily composed of quadrilateral (four-sided) faces. In various embodiments, the quad-dominant mesh may also include some triangles or other polygonal faces as necessary to fit the surface topology of a model. In operation, the iterative quad-dominant remesher 206 first uses world-space neural networks, e.g., o-MLP and p-MLP, to self-learn an orientation field and a position field associated with the extracted triangle mesh. This mechanism jointly optimizes surface and topology. The orientation field defines the preferred alignment direction for the quads on the surface of the mesh. In various embodiments, the orientation field controls the angles at which quads should be oriented to align with certain features or directions on the geometry. The position field specifies where the vertices of the quads should be placed. In various embodiments, the position field determines the spacing and distribution of the quads across the surface of the mesh, controlling how quads should be positioned in a way that respects the orientation field. This helps ensure that the quads are regularly spaced and distributed evenly, avoiding distortion and irregularity in areas with different curvatures or features.

For the orientation field, at each iteration, the o-MLP predicts the initial value ôᵢ for the orientation smoothing at each vertex vᵢ of the triangle mesh:

$$\text{?} ← o - MLP ( {v}_{i} ) \text{?} \frac{\text{?} - {n}_{i} \text{?} , {n}_{i} \text{?}}{‖ \text{?} - {n}_{i} \text{?} , {n}_{i} \text{?} ‖}$$

$$\text{?} \text{indicates text missing or illegible when filed}$$

In various embodiments, the o-MLP learns a full 3D representation of ôᵢ. To supervise the o-MLP network during training of the network, the loss considers π/2-symmetry of the orientation field in the loss, since all integer rotations R(o) around normal nᵢ represent the same quad face orientation. Therefore, the self-learning loss is based on 1−exp(cos θ−1) with an increased winding frequency as outlined in the following loss function:

$$\text{?} ( \text{?} , \text{?} ) = 1 - \frac{1}{\vert 𝒱 \vert} \text{?} exp ( cos ( 4 {θ}_{i} ) - 1 )$$

$$\text{?} \text{indicates text missing or illegible when filed}$$

Where θᵢ is the angle between ôᵢ and oᵢ*, which minimized within the symmetry group.

For the position field, at each iteration, the p-MLP predicts the initial position offset for each vertex vᵢ of the triangle mesh:

$$\text{?} ← tanh ( p - MLP ( {v}_{i} ) ) \text{?} ← \text{?} + \text{?} ∈ {ℝ}^{3}$$

$$\text{?} \text{indicates text missing or illegible when filed}$$

Where the 2D offset \hat{p}ᵢ is projected to the tangent plane of vᵢ using the projection matrix Tᵢ∈R^{3×2}, scaled by the remeshing length s, and used as the initial value for position smoothing. Tᵢ is independent of oᵢ, which decouples the self-learning of \hat{p}ᵢ from the orientation oᵢ*. Measuring the deviation of the predicted position \hat{p}ᵢ and the smoothed pᵢ* is done in tangent space since both are two degree-of-freedom quantities. In various embodiments, the two tangent spaces of \hat{p}ᵢ and pᵢ generally do not have the same basis due to the projection Tᵢ. Therefore, both \hat{p}ᵢ and pᵢ are projected to the lattice aligned with oᵢ* before measuring the deviation according to the following function:

$$\text{?} ( \text{?} ) = \frac{1}{\vert 𝒱 \vert} \text{?} {‖ \frac{1}{\text{?}} [ \begin{matrix}\text{?} \\ {( \text{?} \times {n}_{i} )}^{T}\end{matrix} ] ( \text{?} - \text{?} ) ‖}^{2}$$

$$\text{?} \text{indicates text missing or illegible when filed}$$

In various embodiments, the iterative quad-dominant remesher 206 learns both orientation and position fields for a given triangle mesh jointly. To learn both fields jointly, both the orientation and position field losses are combined as follows:

$$\text{?} = \text{?} + \text{?}$$

$$\text{?} \text{indicates text missing or illegible when filed}$$

By using the stop-gradient operation sg [·] on the smoothed fields o*, p*, the MLPs self-learn the orientation and position fields from their predictions ô, \hat{p}. In particular, at each iteration, the MLPs predict orientation and position values for each vertex of the triangle mesh and use these as a starting point to perform a fixed number of explicit smoothing iterations, which enables self-learning the optimal orientation and position fields.

After orientation and position fields are determined, the iterative quad-dominant remesher 206 extracts a quad-dominant mesh from the position field by collapsing edges referring to the same lattice points. The quad-dominant mesh is primarily composed of quadrilateral (four-sided) faces and is representative of the object included in the input images 202.

The pixel detail extractor 210 performs one or more subdivision operations in a differential manner. In various embodiments, the pixel detail extractor 210 implements a differential subdivision algorithm, e.g., Catmull-Clark subdivision. When implementing the subdivision algorithm, the extracted quad-dominant mesh is iteratively smoothed by subdividing each face into smaller faces, typically quads. This process generates increasingly smooth surfaces by adding new vertices and adjusting the positions of existing ones based on specific averaging rules. The result is a smooth, continuous surface that approximates the original shape but with finer detail. The subdivision process is made “differentiable,” allowing for the calculation of gradients with respect to the mesh vertices. These gradients can be propagated back through the pipeline 200, enabling end-to-end learning where the mesh geometry can be optimized based on a loss function. For example, the differentiable subdivision can allow a network to refine the geometry of a generated mesh by using pixel-level image details as a target. This lets the network learn to adjust the mesh's shape, surface smoothness, and high-frequency details through gradient descent.

In various embodiments, the pixel detail extractor 210 extracts small-scale details by jointly learning a displacement field on the subdivided surface:

$$\text{?} ← \text{?} + d ( \text{?} ) d ( \text{?} ) = \frac{\text{?}}{2} tanh ( d \text{?} MLP ( \text{?} ) )$$

$$\text{?} \text{indicates text missing or illegible when filed}$$

Each vertex is perturbed by the displacement d(vᵢ)∈R³, chosen such that only details smaller than the quad faces are extracted by displacement. In various embodiments, a displacement is a small scale perturbation applied to a surface location to represent fine-scale details. This extraction process implicitly decomposes the surface into a low-frequency mesh with a high-frequency displacement. In particular, since the displacement offsets apply at a much higher subdivided geometry than the quad-dominant mesh, this displacement captures fine-scale details that are not present in the un-subdivided surface. Between the remesher 206 and the pixel detail extractor 210, the pipeline 200 learns a frequency decomposition of the input mesh into large-scale features modeled by the quad-dominant mesh and smaller-scale features modeled by the displacement of the subdivision surface. An artist is able to modify or otherwise control each of the stages of the pipeline 200. For example, an artist may use the displacement offsets to add small-scale detail to the mesh.

The differential renderer 212 renders an image based on the subdivided and displaced quad-mesh. In various embodiments, the differential renderer 212 applies material and lighting models to extract a surface representation with decomposed albedo, metallic, and roughness material parameters as well as an estimated environment lighting map.

The loss computation 214 computes a loss between the image rendered by differential renderer and a reference image of the object. In various embodiments, the various parameters to be optimized in the pipeline 200, including the SDF, orientation fields, position fields, materials and light models are represented by θ. Given reference images I_{ref} with camera pose Tᵢ∈R^{4×4}, the loss is minimized by rendering an image I^{θ}(T) using a differentiable renderer: arg mine E_{T} [Lₜₒₜₐₗ(I^{θ}(T), I^{ref}(T))], where Lₜₒₜₐₗ=L_{img}+Lₘₐₛₖ+λₒₚLₒₚ+λ_{reg}L_{reg}. L_{img}+Lₘₐₛₖ+λₒₚLₒₚ+λ_{reg}L_{reg} include an image space loss, mask loss, the field loss, and regularizers. The loss computed at each execution of the pipeline 200 is propagated to the input mesh generator 204, the pixel detail extractor 210, and the differentiable renderer 212 for subsequent executions to optimize the quad-dominant mesh.

When generating an optimized quad-dominant mesh for a set of input images, several optimization iterations of the pipeline 200 are executed until a target quality or loss is achieved. In various embodiments, the orientation field and the position field determined in one iteration of the pipeline 200 are used as initial values for generating the orientation and position fields in the next iteration.

Once the optimization iterations of the pipeline 200 are executed, the resulting quad-dominant mesh is directly compatible with rendering pipelines, as the pipeline 200 extracts a surface-only representation of the object with suitable topology for subdivision with decomposed material properties. Further, as discussed above, large scale features are represented in the quad-dominant mesh, while smaller scale features, e.g., features that are smaller than the quad-dominant edge length, are represented using displacement. This coarse and fine-grain representation gives an artist operating on the resulting mesh explicit editability of the small scale features.

In various embodiments, the pipeline 200, or portions thereof, can be used in various 3D reconstruction tasks. In various embodiments, artists can control various stages of the pipeline with parameters and modifications that control the resulting quad-dominant mesh. The pipeline 200 can also be used in other tasks. For example, the core idea of remeshing can be applied to 2D splines used in rotoscoping. Given a dense rasterized 2D mask of an object, the pipeline 200 could be used to extract a set of temporally consistent splines fitting the rasterized masks. For this use-case, the remeshing optimization criteria disclosed herein can be changed to account for handle placement of the splines. In such a manner, a rotoscoping workflow can be augmented with segmentation methods while extracting artist-friendly parametric splines.

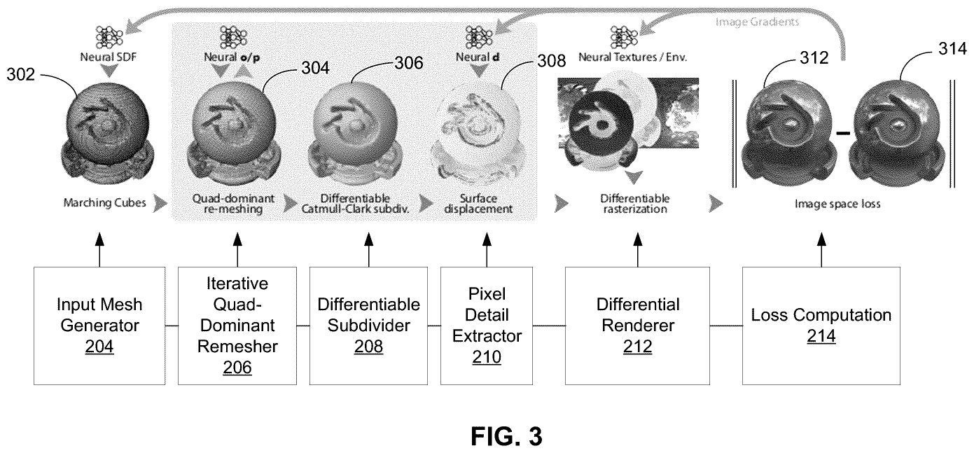

FIG. 3 illustrates an example execution of the mesh generator pipeline 200, according to various embodiments. As shown, the input mesh generator 204 extracts from a neural SDF an input triangle mesh 302. The extraction may be performed using differentiable marching cubes. The iterative quad-dominant remesher 206 self-learns orientation and position fields associated with the input triangle mesh 302 and generates a quad-dominant mesh 304, which is then subdivided by differentiable subdivider 208 to generate the subdivided quad-dominant mesh 306. On top of the subdivided mesh 306, the pixel detail extractor 210 extracts pixel-level details 308 using a neural displacement field. The differential renderer 212 uses one or more differentiable material and lighting models to render an image based on the subdivided and displaced quad-mesh. The loss computation 214 computes a loss between the rendered image 312 and a reference image 314, which is then back-propagated to the neural networks within differential renderer 212, the pixel detail extractor 210, and the input mesh generator 204.

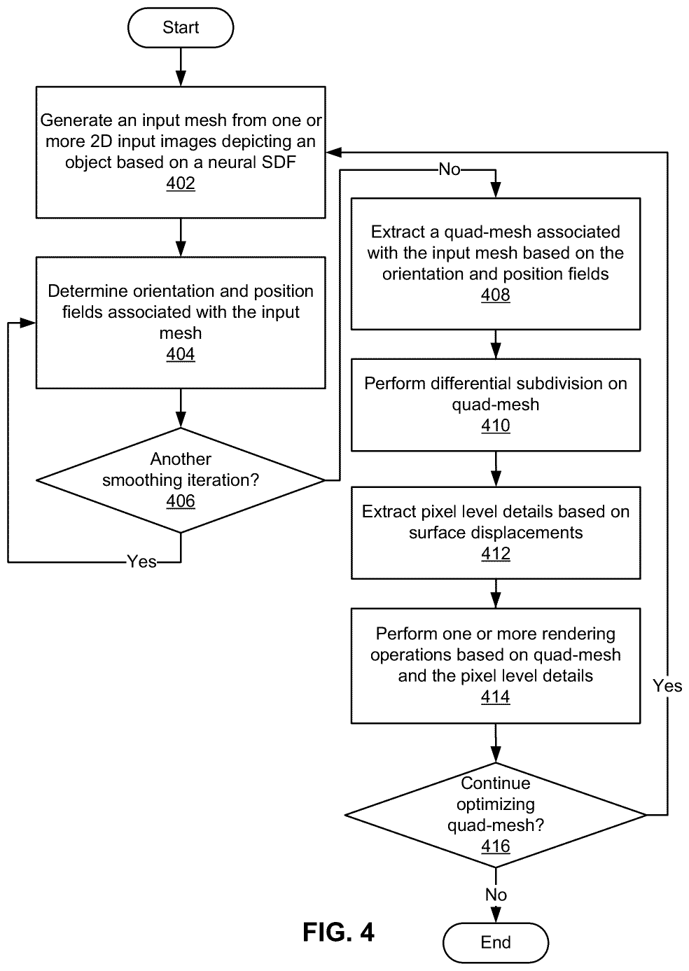

FIG. 4 is a flow diagram of method steps for generating a quad-mesh associated with an object in an input image, according to various embodiments. Although the method steps are described in conjunction with the systems of FIGS. 1-2, persons skilled in the art will understand that any system configured to perform the method steps in any order falls within the scope of the present disclosure.

As shown, in step 402, the pipeline 200 generates an input triangle mesh from one or more 2D input images 202. In various embodiments, the input mesh generator 204 generates a neural signed distance function (SDF) to represent the input images 202. An SDF represents a continuous volumetric field that assigns a value to each point in 3D space that indicates its signed distance from the closest surface. In various embodiments, one or more networks are trained to learn the SDF, enabling accurate modeling of complex shapes and surfaces by encoding them within the network's parameters. The triangle mesh is then generated using the SDF.

At step 404, the pipeline 200 determines an initial orientation field and position field associated with the input mesh. In particular, the pipeline 200 implements one or more neural networks, e.g., MLPs, to predict orientation and position values for each vertex of the triangle mesh and use these as a starting point. At step 406, the pipeline 200 determines whether a smoothing operation on the orientation field and the position field needs to be performed. In various embodiments, the pipeline 200 performs a fixed number of explicit smoothing iterations on the orientation and position fields, which enables self-learning the optimal orientation and position fields. If, at step 406, more smooth operations are to be performed, then the method returns to step 404. If not, then the method proceeds to step 408.

At step 408, after orientation and position fields are determined, the pipeline 200 extracts a quad-dominant mesh from the position field by collapsing edges referring to the same lattice points. The quad-dominant mesh is primarily composed of quadrilateral (four-sided) faces and is representative of the object included in the input images 202.

At step 410, the pipeline 200 performs one or more subdivision operations in a differential manner. In various embodiments, the pipeline 200 implements a differential Catmull-Clark subdivision algorithm. When implementing the Catmull-Clark subdivision algorithm, the extracted quad-dominant mesh is iteratively smoothed by subdividing each face into smaller faces, typically quads. This process generates increasingly smooth surfaces by adding new vertices and adjusting the positions of existing ones based on specific averaging rules. The Catmull-Clark process is made “differentiable,” allowing for the calculation of gradients with respect to the mesh vertices. These gradients can be propagated back through the pipeline 200, enabling end-to-end learning where the mesh geometry can be optimized based on a loss function.

At step 412, the pipeline 200 extracts pixel level details based on learning a displacement field on the subdivided mesh. In various embodiments, the pixel detail extractor 210 extracts small-scale details by jointly learning a displacement field on the subdivided surface:

$$\text{?} ← \text{?} + d ( \text{?} ) d ( \text{?} ) = \frac{\text{?}}{2} tanh ( d \text{?} MLP ( \text{?} ) )$$

$$\text{?} \text{indicates text missing or illegible when filed}$$

Each vertex is perturbed by the displacement d(vᵢ)∈R³, chosen such that only details smaller than the quad faces are extracted by displacement. In various embodiments, a displacement is a small scale perturbation applied to a surface location to represent fine-scale details.

At step 414, the pipeline renders an image based on the subdivided and displaced quad-mesh. In various embodiments, the differential renderer 212 applies material and lighting models to extract a surface representation with decomposed albedo, metallic, and roughness material parameters as well as an estimated environment lighting map. At step 416, the pipeline 200 determines whether to continue optimizing the quad-dominant mesh by computing a loss between the image rendered by differential renderer and a reference image of the object. In various embodiments, the various parameters to be optimized in the pipeline 200, including the SDF, orientation fields, position fields, materials and light models are represented by θ. Given reference images I_{ref} with camera pose Tᵢ∈R^{4×4}, the loss is minimized by rendering an image I^{θ}(T) using a differentiable renderer: arg mine E_{T} [Lₜₒₜₐₗ(I^{θ}(T), I^{ref}(T))], where Lₜₒₜₐₗ=L_{img}+Lₘₐₛₖ+λₒₚLₒₚ+λ_{reg}L_{reg}. L_{img}+Lₘₐₛₖ+λₒₚLₒₚ+λ_{reg}L_{reg} include an image space loss, mask loss, the field loss, and regularizers. The loss computed at each execution of the pipeline 200 is propagated to the input mesh generator 204, the pixel detail extractor 210, and the differentiable renderer 212.

Once the optimization iterations of the pipeline 200 are executed, the resulting quad-dominant mesh is directly compatible with rendering pipelines, as the pipeline 200 extracts a surface-only representation of the object with suitable topology for subdivision with decomposed material properties.
CLAUSE 1. In some embodiments, a computer-implemented method comprises generating, via at least one of a first set of machine learning models, a three-dimensional (3D) triangle mesh of an object based on one or more two-dimensional input images of the object, iteratively learning, via a second set of machine learning models, an orientation field and a position field associated with a set of vertices included in the 3D triangle mesh, extracting a quad-dominant mesh associated with the object from the 3D triangle mesh based on the orientation field and the position field, wherein the quad-dominant mesh comprises one or more quadrilaterals, rendering an image based on the quad-dominant mesh, and optimizing the quad-dominant mesh by propagating a loss generated based on the image to the first set of machine learning models.
CLAUSE 2. The computer-implemented method of clause 1, wherein the 3D triangle mesh is generated based on a signed distance function (SDF) learned by the at least one of the first of machine learning models.
CLAUSE 3. The computer-implemented method of any of clauses 1-2, wherein iteratively learning the orientation field and the position field comprises performing one or more smoothing operations on an initial orientation field and an initial position field.
CLAUSE 4. The computer-implemented method of any of clauses 1-3, wherein, during the optimizing, learning a second orientation field and a second position field based on the orientation field and the position field.
CLAUSE 5. The computer-implemented method of any of clauses 1-4, wherein the second set of machine learning models comprise one or more multilayer perceptron neural networks.
CLAUSE 6. The computer-implemented method of any of clauses 1-5, further comprising performing one or more differentiable subdivision operations on the quad-dominant mesh, wherein the image is rendered based on a subdivided mesh resulting from the one or more differentiable subdivision operations.
CLAUSE 7. The computer-implemented method of any of clauses 1-6, further comprising extracting pixel-level detail from the quad-dominant mesh based on surface displacements determined via at least one of the first set of machine learning models.
CLAUSE 8. The computer-implemented method of any of clauses 1-7, wherein rendering the image comprises determining material and lighting properties associated with the quad-dominant mesh.
CLAUSE 9. The computer-implemented method of any of clauses 1-8, wherein one or more parameters of the first set of machine learning models are controllable by a user.
CLAUSE 10. The computer-implemented method of any of clauses 1-9, wherein optimizing comprises iteratively performing one or more of the generating, iteratively learning, extracting, and rendering steps.
CLAUSE 11. In some embodiments, one or more non-transitory computer-readable media store instructions that, when executed by one or more processors, cause the one or more processors to perform the steps of generating, via at least one of a first set of machine learning models, a three-dimensional (3D) triangle mesh of an object based on one or more two-dimensional input images of the object, iteratively learning, via a second set of machine learning models, an orientation field and a position field associated with a set of vertices included in the 3D triangle mesh, extracting a quad-dominant mesh associated with the object from the 3D triangle mesh based on the orientation field and the position field, wherein the quad-dominant mesh comprises one or more quadrilaterals, rendering an image based on the quad-dominant mesh, and optimizing the quad-dominant mesh by propagating a loss generated based on the image to the first set of machine learning models.
CLAUSE 12. The one or more non-transitory computer-readable media of clause 11, wherein the 3D triangle mesh is generated based on a signed distance function (SDF) learned by the at least one of the first set of machine learning models.
CLAUSE 13. The one or more non-transitory computer-readable media of any of clauses 11-12, wherein iteratively learning the orientation field and the position field comprises performing one or more smoothing operations on an initial orientation field and an initial position field.
CLAUSE 14. The one or more non-transitory computer-readable media of any of clauses 11-13, wherein, during the optimizing, learning a second orientation field and a second position field based on the orientation field and the position field.
CLAUSE 15. The one or more non-transitory computer-readable media of any of clauses 11-14, wherein the second set of machine learning models comprise one or more multilayer perceptron neural networks.
CLAUSE 16. The one or more non-transitory computer-readable media of any of clauses 11-15, further comprising performing one or more differentiable subdivision operations on the quad-dominant mesh, wherein the image is rendered based on a subdivided mesh resulting from the one or more differentiable subdivision operations.
CLAUSE 17. The one or more non-transitory computer-readable media of any of clauses 11-16, further comprising extracting pixel-level detail from the quad-dominant mesh based on surface displacements determined via at least one of the first set of machine learning models.
CLAUSE 18. The one or more non-transitory computer-readable media of any of clauses 11-17, wherein rendering the image comprises determining material and lighting properties associated with the quad-dominant mesh.
CLAUSE 19. The one or more non-transitory computer-readable media of any of clauses 11-18, wherein one or more parameters of the first set of machine learning models are controllable by a user.
CLAUSE 20. A system, comprising one or more memories that store instructions, and one or more processors that are coupled to the one or more memories and, when executing the instructions, are configured to perform the steps of generating, via at least one of a first set of machine learning models, a three-dimensional (3D) triangle mesh of an object based on one or more two-dimensional input images of the object, iteratively learning, via a second set of machine learning models, an orientation field and a position field associated with a set of vertices included in the 3D triangle mesh, extracting a quad-dominant mesh associated with the object from the 3D triangle mesh based on the orientation field and the position field, wherein the quad-dominant mesh comprises one or more quadrilaterals, rendering an image based on the quad-dominant mesh, and optimizing the quad-dominant mesh by propagating a loss generated based on the image to the first set of machine learning models.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
generating, via at least one of a first set of machine learning models, a three-dimensional (3D) triangle mesh of an object based on one or more two-dimensional input images of the object;
iteratively learning, via a second set of machine learning models, an orientation field and a position field associated with a set of vertices included in the 3D triangle mesh;
extracting a quad-dominant mesh associated with the object from the 3D triangle mesh based on the orientation field and the position field, wherein the quad-dominant mesh comprises one or more quadrilaterals;
rendering an image based on the quad-dominant mesh; and
optimizing the quad-dominant mesh by propagating a loss generated based on the image to the first set of machine learning models.

2. The computer-implemented method of claim 1, wherein the 3D triangle mesh is generated based on a signed distance function (SDF) learned by the at least one of the first of machine learning models.

3. The computer-implemented method of claim 1, wherein iteratively learning the orientation field and the position field comprises performing one or more smoothing operations on an initial orientation field and an initial position field.

4. The computer-implemented method of claim 1, wherein, during the optimizing, learning a second orientation field and a second position field based on the orientation field and the position field.

5. The computer-implemented method of claim 1, wherein the second set of machine learning models comprise one or more multilayer perceptron neural networks.

6. The computer-implemented method of claim 1, further comprising performing one or more differentiable subdivision operations on the quad-dominant mesh, wherein the image is rendered based on a subdivided mesh resulting from the one or more differentiable subdivision operations.

7. The computer-implemented method of claim 1, further comprising extracting pixel-level detail from the quad-dominant mesh based on surface displacements determined via at least one of the first set of machine learning models.

8. The computer-implemented method of claim 1, wherein rendering the image comprises determining material and lighting properties associated with the quad-dominant mesh.

9. The computer-implemented method of claim 1, wherein one or more parameters of the first set of machine learning models are controllable by a user.

10. The computer-implemented method of claim 1, wherein optimizing comprises iteratively performing one or more of the generating, iteratively learning, extracting, and rendering steps.

11. One or more non-transitory computer-readable media storing instructions that, when executed by one or more processors, cause the one or more processors to perform the steps of:
generating, via at least one of a first set of machine learning models, a three-dimensional (3D) triangle mesh of an object based on one or more two-dimensional input images of the object;
iteratively learning, via a second set of machine learning models, an orientation field and a position field associated with a set of vertices included in the 3D triangle mesh;
extracting a quad-dominant mesh associated with the object from the 3D triangle mesh based on the orientation field and the position field, wherein the quad-dominant mesh comprises one or more quadrilaterals;
rendering an image based on the quad-dominant mesh; and
optimizing the quad-dominant mesh by propagating a loss generated based on the image to the first set of machine learning models.

12. The one or more non-transitory computer-readable media of claim 11, wherein the 3D triangle mesh is generated based on a signed distance function (SDF) learned by the at least one of the first set of machine learning models.

13. The one or more non-transitory computer-readable media of claim 11, wherein iteratively learning the orientation field and the position field comprises performing one or more smoothing operations on an initial orientation field and an initial position field.

14. The one or more non-transitory computer-readable media of claim 11, wherein, during the optimizing, learning a second orientation field and a second position field based on the orientation field and the position field.

15. The one or more non-transitory computer-readable media of claim 11, wherein the second set of machine learning models comprise one or more multilayer perceptron neural networks.

16. The one or more non-transitory computer-readable media of claim 11, further comprising performing one or more differentiable subdivision operations on the quad-dominant mesh, wherein the image is rendered based on a subdivided mesh resulting from the one or more differentiable subdivision operations.

17. The one or more non-transitory computer-readable media of claim 11, further comprising extracting pixel-level detail from the quad-dominant mesh based on surface displacements determined via at least one of the first set of machine learning models.

18. The one or more non-transitory computer-readable media of claim 11, wherein rendering the image comprises determining material and lighting properties associated with the quad-dominant mesh.

19. The one or more non-transitory computer-readable media of claim 11, wherein one or more parameters of the first set of machine learning models are controllable by a user.

20. A system, comprising:
one or more memories that store instructions; and
one or more processors that are coupled to the one or more memories and, when executing the instructions, are configured to perform the steps of:
generating, via at least one of a first set of machine learning models, a three-dimensional (3D) triangle mesh of an object based on one or more two-dimensional input images of the object;
iteratively learning, via a second set of machine learning models, an orientation field and a position field associated with a set of vertices included in the 3D triangle mesh;
extracting a quad-dominant mesh associated with the object from the 3D triangle mesh based on the orientation field and the position field, wherein the quad-dominant mesh comprises one or more quadrilaterals;
rendering an image based on the quad-dominant mesh; and
optimizing the quad-dominant mesh by propagating a loss generated based on the image to the first set of machine learning models.
